(19) United States
(12) Patent Application Publication
(10) Pub. No.: US 2002/0077723 A1
(43) Pub. Date: Jun. 20, 2002

(54) Production system

(76) Inventor: Ronald Schoop, Hainburg (DE)

Correspondence Address: DENNISON, SCHEINER, SCHULTZ & WAKEMAN, Suite 612, 1745 Jefferson Davis Highway, Arlington, VA, 22202, US

(21) Appl. No.: 09/940,694

(22) Filed: Aug. 29, 2001

(30) Foreign Application Priority Data
Aug. 29, 2000 (DE) 100 42 481.3

(51) Int. Cl. G06F 7/00

(52) U.S. Cl. 700/225; 700/226

(57) ABSTRACT

The invention relates to a production system (10), including a transport system (20, 22, 24, 26, 28) for transporting work pieces (16) preferably mounted on work piece carriers (33) between processing machines, whereby the work pieces (16) and/or the work piece carriers (33) have a data memory in which chiefly data for identifying, processing and/or transporting the work piece and/or the work piece carrier are contained. In order to make available intelligent, independently operating work pieces or work piece carriers, it is provided that the work piece (16) and/or the work piece carrier (33) have at least one active control unit (18) (work piece agent) with programming and data memory for independent control of the work piece (16) and/or the work piece carrier (33), that the active control unit (work piece agent) communicates with additional active control units of the transport system (transport agents) (30) and/or processing machines (machine agents) (14) in order to control its own behavior independently as a function of the operational status of further control units (14, 30).

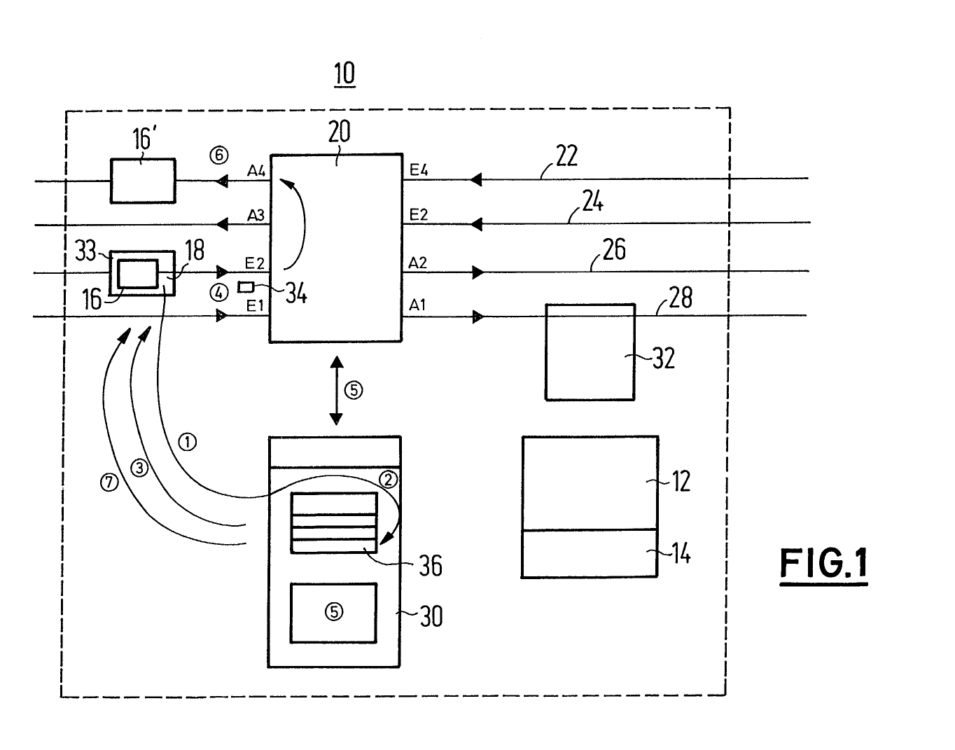

The invention relates to a production system, including a transport system for transporting chiefly work pieces mounted on work piece carriers between processing machines, whereby the work pieces and/or the work piece carriers have a data memory in which chiefly data for the identification, processing and/or transport of the work piece and/or the work piece carrier are contained.

A production system of the previously named type is known from EP 0 654 721 A1. The known production system has a large number of palettes for outfitting with work pieces and/or tools, a setting up place for outfitting palettes as well as a great number of transportable palette magazines for depositing work pieces or tools on palettes. The loaded palettes are transported by means of an automatic transport system on a traffic network between various processing machines. Each palette is provided with a data memory in which data for the identification of the work piece or tool clamped on the palette as well as the data controlling the processing of the work piece are stored.

Furthermore, each palette magazine has a data memory in which data for the identification of the palette magazine and the data controlling the transport of the same are stored. Furthermore, an internal data network for data transfer between the data memories of the palettes and palette magazine and the various processing machines and the transport system is provided. In other words, as regards the data memories described, it is a matter of passive units, which indeed make identification possible, but which cannot actively and flexibly intervene in the production process. There especially is no possibility that the work piece unit or the palette magazine could make decisions independently.

Proceeding from this, underlying the invention is the problem of refining a production system of the previously named type such that intelligent, independently operating work pieces or work piece carriers are made available.

The problem is solved in accordance with the invention in that the work piece and/or the work piece carrier has at least one active control unit (work piece agent) with program and data memory for independent control of the work piece and/or work piece carrier, that the active control unit (work piece agent) communicates with further active control units of the transport system (transport agents) and/or processing machines (machine agents) in order to control independently its own behavior as a function of the operating state of further control units.

Through the embodiment of the invention, the advantage is obtained that by means of the active control unit (work piece agent), conditions of processing machines and/or the transport system can be queried and analyzed already when the work piece is transferred into the production system. In accordance with a load, for example, of a processing machine, it can then be independently decided through the work piece agents of the work piece on the basis of a stored program which processing machine is preferably to be started. Correspondingly, signals are also then sent to the active control units of the transport system and/or of the processing machines.

In contrast to the state of the art, a flexible and intelligent work piece flow is guaranteed, as a work piece stagnation is can be recognized early and dealt with “on site” with adjacent active control units in order to obtain an optimal avoidance opportunity.

A preferred embodiment provides that the active control unit of the work piece carrier and/or the work piece communicates with further active control units of work pieces and/or work piece carriers, transport systems and/or processing machines through a wireless communication connection. In this way, the need to install expensive data networks as well as problems regarding data transmission between mobile work piece carriers and/or work pieces with sensor interfaces for optical or magnetic data transmission arranged at the edge of a transport track disappears.

In a further preferred embodiment, it is provided that the work piece carrier is constructed as a self-sufficient mobile unit, whereby the mobile unit has an additional active control unit (transport agent) in addition to the previously described active control unit (work piece agent) which controls the actions of the work piece carrier. Of course, there exists the possibility of work piece agents and/or transport agents communicating with one another and/or with the active control units of processing machines (machine agents) to optimize the production process.

For communication between active control units, it is provided that these in any given case have transmission and receiving units.

Further particularities, features and advantages of the invention emerge not only from the claims and the features to be gathered from these-in isolation and/or in combination-but also from the following description of a preferred embodiment represented in the drawing.

The sole FIGURE shows a section of a production system 10 in schematic representation. The production system 10 includes processing machines 12, machine agents 14 assigned to the processing machines, work pieces 16, 16′, work piece agents 18 allocated to the work pieces as well as transportation means 20, 22, 24, 26, 28 for transporting work pieces 16, 16′ between the machines 12. The means of transport are assigned to transport agents 30.

The means of transportation 20 are constructed as a sliding table, especially as a sliding table, rotary table or as a rotation element such as a revolver cylinder, in order to enable changing the work pieces 16, 16′ between additional transportation means 22, 28 constructed as transport tracks.

The transport tracks 22 to 28 are constructed as roller tracks whereby the transport tracks 26, 28 are arranged at the edge and driven in the direction of production, and transport tracks 22, 24 are driven in the direction opposite to production and therewith opposed to the direction of travel of transport tracks 26, 28. In addition, a transfer facility 32 is provided which connects the machine 12, for example, with transport track 28.

In accordance with the invention, it is provided that the work piece agent 18 is incorporated as an active control unit in the work piece 16 itself or in a work piece carrier 33 and has a program and data memory for automatic control of the work piece and/or the work piece carrier. Furthermore, it is provided that the work piece agent 18 has transmitting and receiving apparatus in order to communicate with the machine agents 14 and the transport agents 30 as well as a central control unit in order to be able to intervene actively into the production process. The machines and transport agents can also have sending and receiving equipment for this.

Work piece 16, 16′ is attended to during an entire finishing process by work piece agent 18. Before or as soon as the work piece 16, 16′ is introduced into production system 10, the necessary processings are communicated to the work piece agent which this stores. Different processing operations are to be undertaken with reference to a specified work piece type such as, for example, four or six cylinder motor block. In the further course of finishing, the work piece agent ensures that all necessary processing operations are furnished on the work piece. In particular, the work piece agent verifies, preferably through wireless communication, the availability of processing machines 12 with machine agents, ascertains the most favorable processing machine and occasions the transport to this machine. In particular, the work piece agent 18 negotiates (preferably through a wireless communications connection, such as a spark gap) with transport and/or machine agents 30, 14 to set up an optimal production process.

As soon as the work piece 16 is attended to by the work piece agent, the latter communicates with the machine agents 14 assigned to the machines 12 which transmit the respective processing status to the work piece agent. Subsequently, the work piece agent 18 selects the most favorable of the offers received, taking into consideration the respective degree of occupation of the machines 12 addressed.

The sliding unit 20 is managed by transport agent 30. The transport agent is in a position to control the sliding unit 20 independently. If the work piece 16 is transported to the sliding unit 20 through transport band 26 in the direction of production, this is stopped at entry E2 and recorded by a sensor 34.

In a first processing step V1, the work piece agent 18 charges the transport agent 30 with transporting the work piece 16 to a desired target machine address.

In a second processing step V2, the transport order is deposited on an order list 36 and completed in accordance with the order of order inputs. Subsequently transport agent 30 provides a receipt for the transport order and sends a receipt signal back to the work piece agent 30 (processing step V3). In a processing step V4, the transport agent 30 autonomously decides on a certain target output to which the work piece 16 lying at entry E2 is to be transferred in order to reach the target machine address Mz in an optimal manner.

After the transport agent 30 has defined a target output, a transfer program implemented in the transport agent is started (processing step V5), so that the transfer order can be carried out.

The work piece 16′ is discharged to the desired target output (A4 in the embodiment represented) and transported over transport track 22 in a direction opposite to production (processing step V6).

The process of the invention is especially distinguished in that the production system 10 can easily be changed, since local changes such as, for example, removing and adding machines only need be locally configured.

With the elimination of machine 12 with machine address Mn, for example, only transport agent 30 needs to be reconfigured. The work piece agents managing the work pieces 16 are not influenced by the reconfiguration, as these know only the associated target machine addresses Mz of the work pieces managed by them. It is therefore not necessary for the overall topology of the production system 10 to be stored in each work piece agent. There also exists no necessity for the transport agent to know all machine addresses. For even transport agents 30 can decide themselves which machine address is optimal for the in any given case desired processing step.

An additional embodiment is distinguished in that work piece carrier 33 is constructed as an independently conveyable mobile unit. In this case, the work piece cattier 33 includes work piece agent 18 as well as transport agent 30 which both are constructed as active control units. Through the embodiment of the invention, for example, traditional transport systems become intelligent units which communicate independently with one another and consequently optimize the transport of work pieces and/or their processing.

There also exists the possibility of issuing the work piece agents priorities regarding the transport and/or their processing, so that even within the production system, work pieces are preferably processed according to their priority.

1. Production system (10), including a transport system (20, 22, 24, 26, 28) for transporting work pieces (16) preferably mounted on work piece carriers (33) between processing machines, whereby the work pieces (16) and/or the work piece carriers (33) have a data memory in which chiefly data for identifying, processing and/or transporting the work piece and/or the work piece carrier are contained, characterized in that the work piece (16) and/or the work/piece carrier (33) has an active control unit (18) (work piece agent) with programming and data memory for independent control of the work piece (16) and/or the work piece carrier (33), in that the active control unit (work piece agent) communicates with additional active control units of the transport system (transport agents) (30) and/or processing machines (machine agents) (14) in order to control its own behavior independently as a function of the operational status of further control units (14, 30).

2. Production system according to claim 1, characterized in that the active control unit (18) of the work piece carrier and/or the work piece communicates with further active control units (14, 30) of work pieces and/or work piece carriers, transport systems and/or processing machines through a wireless communications connection.

3. Production system according to claim 1 or 2, characterized in that the work piece carrier (33) is constructed as a self-sufficient mobile unit, whereby the mobile unit has a further active control unit (transport agent) (30) which controls the actions of the work piece carrier in addition to the previously described active control unit (work piece agent) (18).

4. Production system according to at least one of the preceding claims, characterized in that the active control units (14, 18, 30) have a transmitting and receiving unit in any given case.
